(19) United States
(12) Patent Application Publication
(10) Pub. No.: US 2014/0278871 A1
(43) Pub. Date: Sep. 18, 2014

(54) PROVIDING INCENTIVES TO A USER OF A SOCIAL NETWORKING SYSTEM BASED ON AN ACTION OF THE USER

(71) Applicants: Philip John MacGregor, Chicago, IL (US); Keenan Pridmore, Chicago, IL (US)

(72) Inventors: Philip John MacGregor, Chicago, IL (US); Keenan Pridmore, Chicago, IL (US)

(21) Appl. No.: 13/841,011

(22) Filed: Mar. 15, 2013

(51) Int. Cl. G06Q 30/02; G06Q 50/00

(52) U.S. Cl. CPC G06Q 30/0217; G06Q 50/01
USPC 705/14.19

(57) ABSTRACT

A method for providing an incentive to a user of a social networking system based on an action of the user in a third party application starts by receiving the action of the user from the third party application. A communication including a content item representative of the action of the user is then posted in the social networking system. The user may be provided an incentive based on the action of the user in the third party application or on an activity performed using the communication by a connection of the user in the social networking system. Other embodiments are also described.

### FIELD

An embodiment of the invention relates generally to using a social networking system to communicate a user's action to the user's connections and providing an incentive to the user based on the action or the connections' activity in the social networking system.

### BACKGROUND

In lieu of traditional print magazines and newspapers, consumers have turned to websites and blogs covering a wide range of topics including food, fashion, music, and sports for information on their interests. For instance, rather than subscribe to Vogue™ magazine, women can now follow fashion bloggers like FashionToast™ and Style By Kling™ who cover the fashion industry. Their followers often covet their personal style which is prominently showcased in their posts. Accordingly, by including pictures and information on their clothing and accessories in their blog posts, these fashion bloggers are inadvertently advertising for these fashion labels. Similarly, clothing companies are also being advertised by users of websites like Polyvore™. These sites allow their users to act as fashion editors and assemble sets of clothing to be viewed and purchased by other users.

In social networking systems, users may designate other users as connections (or otherwise connect to or form relationships with other users), contribute and interact with media items, use applications, join groups, list and confirm attendance at events, invite connections, and perform other tasks that facilitate social interaction. With the popularity of social networking systems, retailers and consumer goods companies would greatly benefit from advertising in this social media forum through its users in order to effectively reach their connections.

### SUMMARY

In order to effectively advertise in a social media platform, a third party application may use the services of a social networking system to encourage users to showcase the third party's goods and products to their connections by providing incentives to the users.

One embodiment of the invention is a method for providing an incentive to a user of a social networking system based on an action of the user in a third party application. The method starts by receiving the action of the user from the third party application. A communication including a content item representative of the action of the user is then posted in the social networking system. The user may then be provided an incentive based on the action of the user in the third party application or based on an activity performed by a connection using the communication.

Another embodiment of the invention is a non-transitory machine-readable storage medium having stored thereon instruction, when executed by a processor, causes the processor to perform this method for providing an incentive to a user of a social networking system based on an action of the user in a third party application.

In yet another embodiment, a system for providing an incentive to a user of a social networking system based on an action of the user in a third party application includes a processor that causes the system to receive the action of the user from the external server, post a communication including a content item representative of the action of the user, and based on the action of the user in the third party application or based on an activity performed by a connection using the communication, the system provides an incentive to the first device.

In another embodiment, a method for providing an incentive to a user of a social networking system starts with the social networking system receiving from the user a text input including an identifier of a corporate entity and posting a communication including the text input in the social networking system. The communication is then be scraped for the identifier of the corporate entity. When the identifier is determined to be in the communication, the social networking system determines if the corporate entity has an incentive available to provide to the user. When the incentive is available, the social networking system provides the incentive to the user by sending the incentive to the user in a communication that is posted in the social networking system or by sending the incentive to the user in a private message. In some embodiments, the method may further comprise receiving from a connection an activity being performed using the communication. In this embodiment, the incentive provided to the user may also be based on the activity being performed by the connection.

The above summary does not include an exhaustive list of all aspects of the present invention. It is contemplated that the invention includes all systems, apparatuses and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. In the drawings:

FIG. 1 shows a block diagram of an environment of a social networking system according to one embodiment of the invention.

FIG. 2 shows a block diagram of the social networking system according to one embodiment of the invention.

FIG. 3 shows screenshots of an exemplary third party application that allows the user to curate a collection of goods and an exemplary posting in the social network system including a representation of the user's action according to one embodiment of the invention.

FIG. 4 shows screenshots of an exemplary third party application that allows the user to upload a picture or communication describing an event and an exemplary posting in the social network system including a representation of the user's action according to one embodiment of the invention.

FIG. 5 illustrates a flow diagram of an example method for providing incentives based on an action of a user of a social networking system in a third party application according to one embodiment of the invention.

FIG. 6 shows a block diagram illustrating the example method for providing incentives based on an action of a user of a social networking system in a third party application according to one embodiment of the invention.

FIG. 7 illustrates a flow diagram of an example method for providing an incentive to a user of a social networking system according to one embodiment of the invention.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

A social networking system can be used to communicate a user's action to the user's connections. These actions may include references to a company's label or goods such that the user is effectively advertising for the company to his connections. Described in further detail below is an incentive-based methodology that encourages the user to communicate these advertisements for the company in the social networking system.

An online social networking system allows users to associate themselves and establish connections with other users of the social networking system. When two users become connected, they are said to be “connections,” “friends,” “contacts,” or “associates” within the context of the social networking system. Generally being connected in a social networking system allows connected users access to more information about each other than would otherwise be available to unconnected users. Likewise, becoming connected within a social networking system may allow a user greater access to communicate with another user, such as by email (internal and external to the social networking system), instant message, text message, phone, or any other communicative interface. Finally, being connected may allow a user access to view, comment on, download or endorse another user's uploaded content items. Examples of content items include but are not limited to messages, queued messages (e.g., email), text and SMS (short message service) messages, comment messages, messages sent using any other suitable messaging technique, an HTTP link, HTML files, images, videos, audio clips, documents, document edits, calendar entries or events, and other computer-related files.

Users of social networking systems may interact with objects such as content items, user information, user actions (for instance communication made within the social networking system, or two users becoming connections), or any other activity or data within the social networking system. This interaction may take a variety of forms, such as by communicating with or commenting on the object; clicking a button or link associated with affinity (such as a “like” button); sharing a content item, user information or user actions with other users; downloading or merely viewing a content item; or by any other suitable means for interaction. Users of a social networking system may also interact with other users by connecting or becoming friends with them, by communicating with them, or by having common connections within the social networking system. Further, a user of a social networking system may form or join groups, or may become a fan of a fan page. Finally, a social networking system user may interact with content items, websites, other users or other information outside of the context of the social networking system's web pages that are connected to or associated with the social networking system. For instance, an article on a news website might have a “like” button that users of the social networking system can click on to express approval of the article. These interactions and any other suitable actions within the context of a social networking system may be recorded in social networking system data.

The social networking system maintains a user profile for each user. Any action that a particular member takes with respect to another member is associated with each user's profile, through information maintained in a database or other data repository. Such actions may include, for example, adding a connection to the other member, sending a message to the other member, reading a message from the other member, viewing content associated with the other member, attending an event posted by another member, among others. The user profiles may also describe characteristics, such as work experience, educational history, hobbies or preferences, location or similar data, of various users and include data describing one or more relationships between users, such as data indicating users having similar or common work experience, hobbies or educational history. Users can also post messages specifically to their profiles in the form of status updates. Users of a social networking system may view the profiles of other users if they have the permission. In some embodiments, becoming a connection of a user automatically provides the permission to view the user's profile.

The social networking system also attempts to deliver the most relevant information to a viewing user employing algorithms to filter the raw content on the network. Content may be filtered based on the attributes in a user's profile, such as geographic location, employer, job type, age, music preferences, interests, or other attributes, as well as based on the interests of the user with respect to another user who is related to the generated content (e.g., the user who performed an action that resulted in the content or information). Newsfeed stories may be generated to deliver the most relevant information to a user based on a ranking of the generated content, filtered by the user's affinity, or attributes. Similarly, social endorsement information may be used to provide social context for advertisements that are shown to a particular viewing user.

FIG. 1 shows a block diagram of an environment of a social networking system according to one embodiment of the invention. The environment 100 in FIG. 1 illustrates a social networking system 101, a plurality of user electronic devices 102₁-102ₙ (n>1), and an external server 103 connected by a network 105. The network 105 may be a variety of different wired or wireless communications networks and protocols that is supported by the user electronic devices 102₁-102ₙ. These include: a cellular mobile phone network (e.g. a Global System for Mobile communications, GSM, network), including current 2G, 3G and 4G networks and their associated call and data protocols; and an IEEE 802.11 data network (WiFi or Wireless Local Area Network, WLAN).

Users interact with the social networking system 101 using user electronic devices 102₁-102ₙ, respectively. The user electronic devices 102₁-102ₙ may be, for example, a personal computer, a laptop computer, a mobile telephone communication device, a smartphone, or a tablet computer. The user electronic devices 102₁-102ₙ may communicate with the social networking system 101 via an application such as a web browser or native application. Typical interactions between the user electronic devices 102₁-102ₙ and the social networking system 101 include operations such as viewing profiles of other users of the social networking system 101, contributing and interacting with media items, joining groups, listing and confirming attendance at events, checking in at locations, liking certain pages, creating pages, and performing other tasks that facilitate social interaction.

The social networking system also provides application developers with the ability to create applications that extend the functionality of the social networking system to provide new ways for users to interact with each other. For example, an application may provide an interesting way for a user to communicate with other users, or allow users to participate in multiplayer games, or collect some interesting information such as news related to a specific topic and display it to the member periodically. To the applications, the social networking system resembles a platform. In some embodiments, external third party applications 104₁-104ₘ (m>1) running on the external server 103 interact with the social networking system 101. In other embodiments, a version of the external applications 104₁-104ₘ is downloaded and installed on the user electronic device 102₁-102ₙ. In other embodiments, these applications 104₁-104ₘ are stored and run on the social networking system 101.

FIG. 2 shows a block diagram of a social networking system according to one embodiment of the invention. As shown in FIG. 2, the social networking system 101 may comprise a number of storage components used to store information about its users and objects represented in the social networking environment, as well as the relationships among the users and objects. This may take the form of a social graph. The social networking system 101 may additionally comprise components to enable several actions to user devices of the system, as described above.

For instance, in one embodiment, the social graph 201 stores the connections that each user has with other users of the social networking system 101. The social graph 201 may also store second-order connections, in some embodiments. The connections may thus be direct or indirect. In one embodiment, the action store 202 stores actions that have been performed by the users of the social networking system 101, along with an indication of the time associated with those actions and references to any objects related to the actions. The action store 202 may also store actions that have been performed by the users in third party applications 104₁-104ₘ. The social graph 201 and the action store 202 may utilize one or more different types of storage such as hard disk drive storage, other nonvolatile memory, and volatile memory such as dynamic random access memory.

The social networking system 101 may also include platform applications 203₁-203ᵢ (i>1), which are applications that operate within the social networking system 101 but may be provided by third parties other than an operator of the social networking system 101. For instance, platform applications 203₁-203ᵢ may include social games, messaging services, and any other application that uses the social platform provided by the social networking system 101.

The authentication manager 205 authenticates a user on user device 102₁ as being a registered user of the social networking system 101. The authentication manager 205 allows a user to log into the social networking system 101 from any user device 102₁-102ₙ, that has an application supporting the social networking system 101. The application programming interface (API) 204 works in conjunction with the authentication manager 205 to validate users via external third party applications 104₁-104ₘ (m>1).

In some embodiments, the social networking system 101 also includes a processor (not shown) that is coupled to the storage components (e.g., social graph 201, the action store 202), the platform applications 203₁-203ᵢ, the API 204, and the authentication manager 205. The processor may be a microprocessor, a microcontroller, a digital signal processor, or a central processing unit. The term “processor” may refer to a device having two or more processing units or elements, e.g. a CPU with multiple processing cores. The processor may be used to control the operations of social networking system 101 by executing software instructions or code stored in the storage components.

In some embodiments, external third party applications 104₁-104ₘ running on the external server 103 interacts with the social networking system 101 via API 204. The third party applications 104₁-104ₘ can perform various operations supported by the API 204, such as enabling users to send each other messages through the social networking system 101 or showing advertisements from the third party routed through the social networking system 101.

Referring back to FIG. 1, the environment 100 illustrates one embodiment of the system for providing an incentive to a user based on an action of the user in a third party application. In this system 100, a first user on the electronic device 102₁ is a user of the social networking system 101 and a second user on the electronic device 102₂ is a connection of the first user in the social networking system 101. Using the electronic device 102₁, the first user may perform an action in a third party application 104₁ being executed on an external server 103 or on the social networking system 101. In other embodiments, the electronic device 102₁ executes a version of the third party application 104₁. The third party may be an entity such as Company X, a clothing retailer, and the third party application 104₁ may be an application that allows the first user to curate a collection of goods including clothing, shoes, accessories, luggage, beauty products, etc. that may be associated with this entity. FIG. 3 shows screenshots of this exemplary third party application according to one embodiment of the invention. As shown in FIG. 3, the action by the first user in this application may include curating this collection of goods that includes goods that are sold by Company X. The third party application 104₁ may allow the first user to create number of lookbooks (e.g., a collection of images that showcase clothing sets) including goods that are sold by Company X. The collection of goods may also include, for example, goods that are owned by the first user and previously purchased from Company X and goods that the first user wishes to purchase (e.g., a Wish List) from Company X. In other embodiments, the first user curates a collection of goods that are not associated with the third party entity in addition to, or in lieu of, goods associated with the third party entity. In some embodiments, the third party application provides advice to the user on what to curate. Additionally, in some embodiments, the third party application automatically curates goods that have been viewed. This feature may be enabled/disabled by the user. In some embodiments, a second user may subscribe to the first user's pages that use the third party application such that the second user sees, within the third party application or in the social network, what the first user has curated. For example, the second user may be a connection (“friend”) of the first user such that a communication including the first user's lookbook or wishlist appears in the second user's newsfeeds. This communication may include an icon, text, link, or dropdown box that allows the second user to subscribe to communications from the third party application. In another example, both the first and the second users are registered users of the third party application. The second user who is browsing lookbooks or wishlists may enjoy the first user's lookbooks or wishlists and decide to subscribe to the first user's pages via an icon, text, link, or dropdown box being displayed in the third party application. By being subscribed to the first user's pages, this also allows the second user to suggest to the first user what to curate (for example, in response to a solicitation request from the first user) and for the first user to receive this advice from the second user. While the preceding description discussed the utilization of a third party application, the concepts described may also be utilized on the social networking system without such an application.

In another example, the third party entity is a Company Y, a consumer goods company, and the third party application 104₁ is an application that allows the first user to upload at least one of a picture and a communication in the third party application 104₁ that describes an event. FIG. 4 shows screenshots of this exemplary third party application according to one embodiment of the invention. As shown in FIG. 4, the first user uploads a picture of his family dinner with a caption stating: “Family pizza night”. Accordingly, the action by the first user in this application include the uploading of the picture with the caption using the third party application 104₁.

In both examples, the external server 103 receives the action of the first user on the third party application 104₁ from the electronic device 102₁ via the network 105. The external server 103 transmits the action of the first user on the third party application 104₁ to the social networking system 101. In another embodiment, a version of the third party application is being executed on the electronic device 102₁ such that the social networking system 101 receives the action of the first user on the third party application 104₁ directly from the electronic device 102₁ via the network 105. In another embodiment, a version of the third party application is executed on the social networking system 101 and the social networking system 101 receives actions of the first user directly. In another embodiment, the third party provides inventory to the social networking system 101 and a user curates with that inventory information in addition to whatever other information the user wants to supply using the social networking system 101 and not an application 104. For example, a retailer may supply its inventory (and updates to that inventory) to the social networking system 101. A user may then use the social networking system 101 as a platform for curating items from the retailers inventory using that supplied data. The social networking system 101 then posts a communication that includes a content item representative of the action of the first user on the third party application 104₁. Referring back to FIG. 3, an exemplary posting in the social network system including a representation of the user's action according to one embodiment of the invention is illustrated. As shown in FIG. 3, the social networking system 101 creates a post (or communication) to be displayed on the user's profile page that includes a preview of the first user's curated collection of goods (i.e., the “content item”). For instance, the first user may have created a lookbook for an upcoming trip to Portland (“Portland lookbook”) as illustrated in FIG. 3. This lookbook may include clothing that the first user wishes to purchase from Company X at the company's store or website. The social networking system 101 may create communication including a preview or other representation of this Portland lookbook to be displayed on the first user's profile page. Further, this communication or a version of this communication that includes the preview or other representation of this Portland lookbook may also be displayed in the first user's connections' newsfeeds. As illustrated in FIG. 3, the communication being displayed on the first user's profile or in the connection's newsfeeds may also include the name of the third party application that is being used by the first user.

The social networking system 101 may also be configured to receive from a connection an activity being performed using the communication. For instance, having posted a representation of the Portland lookbook on the first user's profile and/or the connection's newsfeeds, the communication may also include icons and text boxes that may receive the connection's input. As shown in FIG. 3, the communication including a preview or other representation of the Portland lookbook includes “like”, “comment”, and “share” icons as well as a link to the Company X's application (i.e., the third party application 1040. Accordingly, the activity that the connection may perform includes commenting on the Portland lookbook, using the Company X application to create her own lookbook or curate her own collection of goods, and expressing an affinity for the Portland lookbook by clicking on a “like” button, and sharing the Portland lookbook with the second user's connections and social network by clicking on a “share” button. In other embodiments, the communication also includes a link to allow the connection to play a game incorporated in the Company X's application such that the activity that the connection may perform includes playing the game.

In the Company Y example, when the social networking system 101 receives the uploaded picture of the user's family dinner with a caption “Family pizza night”, the social networking system 101 generates a communication that states that the first user has used the third party application 104₁ and further includes the uploaded picture of the first user's family dinner with the caption. As shown in FIG. 4, the social networking system 101 posts this communication on the user's profile page, in his connection's newsfeeds, in the connection's ticker which is a real time newsfeed, or in a sponsored story which a communication in the newsfeed that is highlighted because a sponsor such as Company Y has paid to increase the likelihood of the user's connections viewing and performing activities on the communication. Further, the social networking system 101 may receive from a connection an activity being performed using the communication in FIG. 4. Similar to FIG. 3, the communication in FIG. 4 includes a “like”, “comment”, and “share” icons as well as a link to the Company Y's application (i.e., the third party application 1040. In other embodiments, the communication also includes a link to allow the connection to play a game incorporated in the Company Y's application. Accordingly, the activity that the connection may perform includes commenting on the first user's picture of his family dinner, using the third party application 104₁ to upload her own pictures of events, playing a game, and expressing an affinity for the first user's family dinner by clicking on a “like” button, and sharing the picture and the caption of the first user's family dinner with the second user's connections and social network by clicking on a “share” button.

Based on the action of the first user in the third party application using the first device 102₁ or based on the activity performed by the connection using the second device 102₂, the external server 103 or the social networking system 101 then provides an incentive to the first device 102₁. For instance, the incentive that is provided to the first user may be a discount on a purchase from Company X for creating the Portland lookbook. The discount may also be specifically for a purchase of an item included in the Portland lookbook. The discount on a purchase from Company X may also be obtained for at least one of the activities that are performed by the connection. For example, if the connection leaves a comment on the Portland lookbook using her electronic device 102₂, this activity by the connection may result in a discount being sent to the first electronic device 102₁. Instead of discounts on purchases at Company X's store or website, the incentive provided to the first user may also be a number of points associated with Company X's rewards program. In some embodiments, the social networking system 101 also posts a communication that included the incentive that was provided to the first user in order to further advertise the benefits of the third party application as well as the goods and products being sold by the third party. In other embodiments, the third party application 104₁ also allows the first user to view upcoming events in Company X's store and upcoming rewards being offered by Company X. The social networking system 101 may also post in the communication the events that the first user will be attending as well as upcoming rewards for which the first user is either registered or eligible.

In the Company Y example, the external server 103 determines a product that is being sold by the third party that is related to the event depicted in the uploaded picture or described in the communication and the external server 103 then provides a discount on a purchase of the product from the third party. For example, the external server 103 may determine that “Company Y's Pizza” is a pizza that is sold by Company Y and is related (or relevant) to the “Family pizza night” picture and caption uploaded by the first user. The external server 103 may provide a discount on “Company Y's Pizza” to the first device 102₁ for uploading the picture and caption of the pizza dinner event. Further, the external server 103 may also provide the discount based on activity by a connection on this “Family pizza night” picture and caption such as clicking on the “like” button associated with this “Family pizza night” upload. It is noted that if Company Y did not sell pizza, the external server 103 may provide a discount on more generic items that are still related to the “Family pizza night” such as water bottles, soda, coffee, etc. In other embodiments, if the first user uploaded a picture and a caption that mentions a company other than the Company Y, an incentive may still be provided to the user. For instance, the first user may upload a picture and caption that states “Family Dinner—eating Company Z's pizza”, an incentive may be provided to the first user such as a discount on a future purchase of Company Y's pizzas.

The following embodiments of the invention may be described as a process, which is usually depicted as a flowchart, a flow diagram, a sequence diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a procedure, etc.

FIG. 5 illustrates a flow diagram of an example method for providing incentives based on an action of a user of a social networking system in a third party application according to one embodiment of the invention. The method 500 starts by receiving the action of the user from the third party application (Block 501). The action is received by the social networking system 101 from an external server 103 that is executing the third party application 104₁. In another embodiment, the action is received from the electronic device 102₁ that is executing a version of the third party application 104₁. In another embodiment, the action is directly received by social networking system running the third party application 104. At Block 502, a communication including a content item representative of the action of the user is posted in the social networking system. In some embodiments, a processor in the social networking system 101 causes the communication to be posted. In some embodiments, the system receives an action performed by the user on a social network. For example, the user may add an item to a collection via photo tagging on the social network. In this example, the user may tag a winter jacket that the user is wearing in a photo on the social network by clicking on the jacket and identifying the jacket as Company X's jacket Model A. In some embodiments, purchases made by the user using a credit card or other accounts linked to the social network (e.g., Google Pay, PayPal, checking, retailer rewards card, etc.) are automatically added to the collection on behalf of the user.

At Block 503, an additional action is performed by the social network or other entity in response to the action of Block 501. For example, incentive is provided to the user based on the action of the user in the third party application 104₁. For instance, an incentive may be sent to the first device 102₁ to reward the user for creating a lookbook using the Company X's application. At Block 503, an incentive may also be sent to the user based on an activity performed by a connection. For example, the first device 102₁ may receive an incentive from Company X for every “like” the user's lookbook receives. The incentive may be a discount for a purchase of goods from the third party or a number of points in the third party's rewards program. In other embodiments, a communication including the incentive that is received by the user is posted in the social networking system to be viewed by the user's connections. In other embodiments, the data or action that was received at Block 501 causes a real world action to be performed. For example, when an item is curated, a display at one or more of the stores may be changed to indicate that a user has curated the item. This display may be an electronic display that shows a real-time (or delayed) listing of the top curated items, the latest curated item, etc. or a physical storefront type display. This curated information may also be used by the store to determine if an item is popular and if more stock should be ordered, an advertisement placed, etc.; or if the item is not popular is future orders should be halted. In some embodiments, the data or action that was received at Block 501 causes a virtual action to occur such as causing a website (other than the social network) to be updated to reflect the data or action. For example, the website of the store that had an item curated is updated to reflect the top curated items, the latest curated item, etc.

FIG. 6 shows a block diagram illustrating the example method for providing incentives based on an action of a user of a social networking system in a third party application according to one embodiment of the invention. As shown in FIG. 6, the third party application 104₁ which is executed by the external server 103 or by the user's electronic device 102₁ receives a user's action and transmits the action to the social networking system 101 which generates a communication that includes a content item of representative of the action of the user and posts the communication to be viewed by the user's connections. For instance, the communication may be posted in the user's profile page, the connections' newsfeeds, the connections' ticker, etc. The connections using electronic devices 102₂-102ₙ see the posted communications and perform activities using the communication such as “like”, share or comment on the communication displayed. Other activities that may be performed by the connections may include accessing and using the third party application 104₁ via a link included in the communication.

While the preceding description has primarily discussed the utilization of a third party application 104, the concepts described herein may also be utilized on the social networking system 101 without such an application 104. For example, FIG. 7 illustrates a flow diagram of an example method for providing an incentive to a user of a social networking system according to one embodiment of the invention. The method 700 starts with the social networking system receiving from the user a text input including an identifier of a corporate entity (Block 701). For example, the user may provide the text input “Family Dinner—Company X Pizza is the best!” In this example, the text input by the user includes the identifier of the corporate entity: “Company X.” At Block 702, the social networking system posts a communication including the text input in the social networking system. For instance, the social networking system includes the text input “Family Dinner—Company X Pizza is the best!” in a communication that is posted on the user's profile, in a newsfeed, etc. In some embodiments, the input from the user includes a hashtag that signifies a company name or product, and/or an identifier to a particular promotion of the company, etc. At Block 703, the communication is then scraped for the identifier of the corporate entity (name, product, promotion, etc.). In some embodiments, the user has pre-registered his account in the social networking system 101 with the corporate entity in order to allow for the scraping for the identifier. At Block 704, when the identifier is determined to be in the communication, the social networking system 101 determines if the corporate entity has an incentive available to provide to the user. In this example, the social networking system scrapes for the identifier “Company X” and having found this identifier in the communication, the social networking system 101 then determines whether Company X has incentives available to provide to the user. The incentives may include discounts, giveaways, points in a rewards program, promotions, etc. At Block 705, when the incentive is available, the social networking system 101 provides the incentive to the user by sending the incentive to the user in a communication that is posted in the social networking system 101 or by sending the incentive to the user in a private message.

In some embodiments, the method 700 may further comprise receiving from a connection an activity being performed using the communication. For instance, a connection of the user in the social networking system may “like” or comment on the post on the user's profile that includes the text input “Family Dinner—Company X Pizza is the best!” The incentive in this example may be a giveaway from Company X if the post on the user's profile that states “Family Dinner—Company X Pizza is the best!” obtains a given number of “likes” or comments from his connections. Accordingly, in this embodiment, the incentive provided to the user is also based on the activity being performed by the connection. In other embodiments, the social networking system scrapes the communications for a pre-determined phrase or picture that trigger an incentive from the corporate entity such as a promotion or giveaway to be provided to the user.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving the action of a user from a third party application;
posting a communication in the social networking system including a content item representative of the action of the user; and
providing an incentive to the user based on the action of the user in the third party application or based on an activity performed using the communication by a connection of the user in the social networking system.

2. The method of claim 1,
wherein the action of the user includes curating a collection of one or more goods being sold by the third party, and
wherein the content item includes the collection of goods.

3. The method of claim 2, wherein the collection of goods includes goods that are owned by the user and previously purchased from the third party.

4. The method of claim 2, wherein the collection of goods includes goods that the user wishes to purchase from the third party.

5. The method of claim 2, wherein providing the incentive to the user includes one of providing a discount on future purchases made by the user with the third party and a number of points associated with the third party's reward program.

6. The method of claim 1, wherein the action of the user includes uploading at least one of a picture and a communication in the third party application describing an event.

7. The method of claim 6, wherein providing the incentive to the user includes:
determining a product sold by the third party that is related to the event; and
providing a discount on a purchase of the product from the third party.

8. The method of claim 1, wherein the activity includes at least one of: commenting on the content item, using the third party application, playing a game, and expressing an affinity for the content item.

9. A non-transitory machine-readable storage medium having stored thereon instruction, when executed by a processor, causes the processor to perform a method comprising:
receiving the action of a user from a third party application;
posting a communication in the social networking system including a content item representative of the action of the user; and
providing an incentive to the user based on the action of the user in the third party application or based on an activity performed using the communication by a connection of the user in the social networking system.

10. The non-transitory machine-readable storage medium of claim 11,
wherein the action of the user includes curating a collection of goods being sold by the third party including at least one of: articles of clothing, shoes, accessories, luggage, and beauty products, and
wherein the content item includes the collection of goods.

11. The non-transitory machine-readable storage medium of claim 12, wherein providing the incentive to the user includes at least one of: providing a discount on purchases made from the third party, and providing a number of points associated with the third party's reward program.

12. The non-transitory machine-readable storage medium of claim 11, wherein the action of the user includes uploading at least one of a picture and a communication in the third party application describing an event.

13. The non-transitory machine-readable storage medium of claim 14, wherein providing the incentive to the user includes:
determining a product sold by the third party that is related to the event; and
providing a discount on a purchase of the product from the third party.

14. The non-transitory machine-readable storage medium of claim 11, wherein the activity includes at least one of: commenting on the content item, using the third party application, playing a game, and expressing an affinity for the content item.

15. A method comprising:
receiving by a social networking system from a user a text input including an identifier of a corporate entity;
posting a communication in the social networking system including the text input;
scraping the communication for the identifier of the corporate entity;
determining if the corporate entity has an incentive available to provide to the user when the identifier is determined to be in the communication; and
providing the incentive to the user when the incentive available.

16. The method of claim 15 wherein providing the incentive to the user when the incentive available includes at least one of:
sending a promotion to the user in a communication that is posted in the social networking system, and
sending the promotion to the user in a private message.

17. The method of claim 15 further comprising:
receiving from a connection an activity being performed using the communication, wherein the activity includes at least one of: commenting on the content item, using the third party application, and expressing an affinity for the content item, and
wherein the incentive is based on the activity being performed by the connection.
